(19) United States
(12) Patent Application Publication
(10) Pub. No.: US 2026/0357597 A1
(43) Pub. Date: Nov. 12, 2026

(54) System and Method for Constructing a Brick and Mortar Wall

(71) Applicant: ROPAX B.V., Hedel (NL)

(72) Inventors: Jeroen-Bas MENSCHAAR, Hedel (NL); Jelle Floris Joachim OVERTOOM, Hedel (NL); Erik Laurens VAN DER HOEVEN, Hedel (NL)

(73) Assignee: ROPAX B.V., Hedel (NL)

(21) Appl. No.: 19/124,907

(22) PCT Filed: Oct. 26, 2023
(86) PCT No.: PCT/NL2023/050562

§ 371 Date: Apr. 28, 2025

(30) Foreign Application Priority Data
Oct. 26, 2022 (NL) 2033401

(51) Int. Cl. E04G 21/22; E04G 21/20

(52) U.S. Cl. CPC E04G 21/22; E04G 21/202

(57) ABSTRACT

A system for constructing a brick wall, and a method using such a system. The system includes a base, a hopper for mortar, a pump having a stator and a rotor and in fluid connection with the hopper, and an outlet section in fluid communication with an outlet opening of the stator and adjacent thereto. A mortar depositing device is utilized in which it has an opening for depositing mortar. A mortar supply line interconnects the mortar depositing device with the outlet section. A robot has a grabber adapted for picking up a brick from a brick supply device and the robot includes a control system adapted for controlling the robot to pick up a brick from the brick supply device and place it to form part of the wall. The mortar depositing device is adapted for being picked up by the grabber, and for being held by the grabber.

### FIELD OF INVENTION

The present invention relates to a system and a method for constructing a brick and mortar wall, in particular wherein the wall comprises real bricks or blocks having the same shape and function as bricks. The bricks typically are bricks that could also be handled manually by a brick mason without the use of power tools. The mortar may for instance be a thin-bed mortar, a masonry mortar or an adhesive mortar, e.g. as may be respectively used for mortar joins having heights in the range of 8-15 mm, 4-8mm or 2-5 mm. A major component of the mortar typically is formed by sand, mud and/or cement. The present invention further relates to an assembly, e.g. for use in the system of the invention, wherein the assembly comprises a pump for pumping mortar and further comprises an outlet section in fluid communication with a stator of the pump.

### BACKGROUND

Robotically assisted brick laying systems are known, for instance from US 2012/0053726 which describes a system comprising: a gantry having a moveable platform; a robotic arm assembly mounted to the moveable platform; control software operatively coupled to said robotic arm assembly; a mortar applicator, such as a progressive cavity pump, mounted to the moveable platform; a mortar transfer device operatively coupled to said mortar applicator; a brick transfer device; and a sensing and positioning component controlling placement of the moveable platform and robotic arm assembly. US 2012/0053726 describes that a mortar dispenser line couples the mortar applicator to the mortar transfer device, and that the brick transfer device is adapted for picking up a brick and transporting the brick to the mortar applicator device to allow the mortar application device to apply mortar on top of the brick.

A drawback of the known system is that it is less suitable for use with a mortar which has a relatively low viscosity, due to the mortar on the brick flowing during movement of the brick towards the partially constructed wall.

It is an object of the invention to provide a system, assembly, and method which at least partially overcome this drawback.

### SUMMARY

To this end, according to a first aspect the invention provides a system for constructing a brick wall, comprising: a base; a hopper mounted to the base and adapted for holding mortar therein, the hopper comprising an inlet opening and an outlet opening; a pump for pumping mortar, the pump comprising a stator and a rotor at least partially arranged within the stator, the stator comprising an inlet opening in fluid communication with the outlet opening of the hopper, the stator further comprising an outlet opening, wherein the rotor is arranged for rotating in a first direction to pump mortar from the stator through the outlet opening of the stator; an outlet section in fluid communication with the outlet opening of the stator and adjacent thereto; a mortar depositing device having one or more openings for depositing mortar; a mortar supply line interconnecting the mortar depositing device with the outlet section; an arm moveable relative to the base, the arm comprising a grabber, wherein the grabber is moveable relative to the base and adapted for picking up a brick from a brick supply device; and a control system adapted for controlling the arm and grabber to pick up a brick from the brick supply device and place it to form part of the wall; wherein the mortar depositing device is adapted for being picked up by the grabber, and for being held by the grabber while the grabber moves relative to the base; wherein the control system further is adapted for:—controlling the arm and the grabber to move the mortar depositing device held by the grabber relative to the base while the mortar depositing device deposits one or more layers of mortar and while the grabber is stationary relative to the mortar depositing device.

The system of the invention may be used for depositing mortar at a location where a wall is being constructed, without first depositing mortar on a brick that is yet to be placed on a partially constructed wall. This allows the system deposit an initial bottom layer of mortar on top of a foundation or the like, in particular before any bricks have been placed in the wall, and subsequently place a row of multiple bricks on the bottom layer. When depositing mortar, the mortar depositing device will typically be moved by the arm and the grabber over a top side of the partially constructed wall.

In an embodiment the system further comprises: a drive means for driving rotation of the rotor relative to the stator; and a pressure sensor arranged for measuring a pressure of mortar downstream of the rotor, preferably wherein the pressure sensor is arranged for measuring a pressure of mortar in the outlet section, in the mortar supply line and/or in the mortar depositing device; wherein the controller is further adapted for controlling the drive means such that the pressure measured by the pressure sensor while the device deposits the one or more layers of mortar remains substantially in the range of 0 to 5 atm above atmospheric pressure, preferably in the range of 1 to 5 atm above atmospheric pressure.

In this manner it is substantially to avoided that the sand water in the mortar separate from each other due to high pressure, e.g. a pressure of 7 atm or greater, on the mortar. This allows mortar with a relatively low viscosity to be used which would be unsuitable to be pumped at higher pressure without the sand separating from the water. Mortars suitable for use with the system of the invention, in particular when pumped at pressures within the above mentioned pressure range, typically have a value of the slump test as measured according to ISO standard EN 12350-2:2019 of between 22 and 40 cm, in particular between 24 and 38 cm.

The system may comprise one or more additional pressure sensors to measure atmospheric pressure and/or the control system may be adapted to calculate the pressure of the mortar relative to atmospheric pressure based on the pressure of the mortar in the outlet section, mortar supply line and/or in the mortar depositing device as measured by the pressure sensor. The system may be provided with multiple pressure sensors for measuring pressure of the mortar, e.g. a pressure sensor for measuring a pressure of the mortar in the outlet section downstream of the stator, a pressure sensor for measuring a pressure of the mortar in the mortar supply line, and/or a pressure sensor for measuring a pressure of the mortar in the mortar depositing device.

In an embodiment, the control system further is adapted for, upon the pressure sensor measuring a sudden drop in pressure, controlling the drive means to rotate in a second direction opposite to the first direction. In this manner mortar in the mortar depositing device can be at least partially prevented from exiting via the opening of the device, e.g. onto a brick. A sudden pressure drop may for instance be defined as a drop in pressure of 0.5 atm or more within three seconds, preferably within 1 or 2 seconds.

In an embodiment the control system is adapted for controlling the arm and the grabber holding the mortar depositing device to move to a recycle position in which the one or more openings are arranged for depositing mortar into the hopper. When in the recycle position, mortar can thus be pumped, from the hopper, through the mortar depositing device back into the hopper, to ensure that the mortar depositing device and the mortar supply line are sufficiently filled with mortar and ready to be used to deposit mortar when the grabber is moved out of the recycle position. Moreover, by recycling mortar when in the recycle position, any air pockets in the mortar depositing device and/or in the mortar supply line may be substantially removed, resulting in more contiguous deposition of mortar. Additionally, recycling mortar from the mortar supply line helps prevent mortar from curing within the supply line.

When in the recycle position, which preferably is a fixed position relative to the hopper and may be a position on the hopper, the mortar depositing device is typically arranged such that mortar that is pumped out of the mortar depositing device falls back into the hopper via the inlet opening of the hopper.

In an embodiment the control system further is adapted for controlling the arm and the grabber holding the mortar depositing device to move to the recycle position in case of a sudden drop, e.g. a drop in pressure of 0.5 atm or more within three seconds, preferably within 1 or 2 seconds, in pressure measured by the pressure sensor. Such a sudden drop in measured pressure is typically indicative of an air pocket in the pump.

In an embodiment the control system is adapted for controlling the arm and the grabber holding the mortar depositing device to move to a standby position and then release the mortar depositing device at said position. Once a layer of mortar has been deposited, the grabber no longer has to hold the mortar depositing device and the arm and grabber can be controlled by the control system to pick up a brick and place it on the layer of mortar. Typically, multiple bricks will be placed on a same layer of mortar that was deposited by the mortar depositing device.

Generally, the control system is further adapted for controlling the arm and grabber to move to the standby position and pick up and hold the mortar depositing device. Thus, after the arm and grabber have been used to place one or more bricks on a layer of mortar, the mortar depositing device that is held by the grabber can be used to place a layer of mortar on top of those bricks.

In an embodiment the drive means comprises a rod which extends into the hopper and is provided with a fin along part of its longitudinal direction, for preventing air from being mixed into the mortar when the rod rotates.

In an embodiment the control system is adapted to control the drive means to rotate the rotor in a second direction opposite to the first direction at the end of depositing one or more layers of mortar. Thus, while one or more layers of mortar are deposited the drive means will rotate in the first direction, and at the end of the depositing the drive means rotate in the opposite direction, to substantially prevent excess mortar being deposited and/or prevent mortar from leaking, e.g. when the mortar depositing device is moved to the standby or recycle position.

In an embodiment, the controller is adapted for controlling the arm and grabber to pick up a brick while the mortar depositing device is in the standby or recycle position.

In an embodiment a circumferential inner wall surface of the stator connects substantially smoothly to a circumferential inner wall surface of the outlet section, wherein the outlet section defines a passage for mortar along a center axis, and wherein a cross-sectional area in a plane perpendicular to said center axis and bounded by the inner wall surface of the outlet section decreases in a downstream direction along the axis. Thus, mortar can flow smoothly from the stator to the outlet section, and from the outlet section to the mortar supply line, while it is substantially prevented that mortar remains in so called “dead zones” within the outlet section. The center axis typically will be a curve with a single point of inflexion.

In an embodiment the cross-sectional area of the upstream end of the passage is no more than 3 times the cross-sectional area of the downstream end of the passage. Thus, the outlet section narrows considerably from its upstream end to its downstream end, in this manner further preventing portions of mortar from becoming lodged in the outlet section, helping to ensure substantially uniform retention time of mortar in the outlet section.

In an embodiment the outlet section is spaced apart from the rotor and is detachably attached to the stator, preferably wherein the outlet section is detachably attached to the stator in such a manner that the outlet section can be detached from and attached to the stator without moving the rotor relative to the stator. This allows the outlet section to be replaced, or be temporarily removed, e.g. for cleaning and/or to allow access to an interior downstream side of the stator.

Preferably the outlet section is detachable from and attachable to the stator by sliding the outlet section relative to the stator, e.g. in a direction substantially normal to the axis of rotation of the rotor.

In an embodiment the pump is provided with a blocking element for blocking movement of the rotor out of a lower side of the pump during use, wherein the blocking element is arranged for contacting a lower surface of the rotor within a volume defined by the stator. Preferably, the blocking element comprises a shaft that is held in the stator and has an upward facing surface for contacting the lower surface of the rotor.

In an embodiment the mortar supply line has a length of between 0.5 and 6 m, preferably between 1.5 and 2.5 m. The relatively short supply line allows the system to use a pump that pumps the mortar at a relatively low pressure of between 1 and 5 atm above atmospheric pressure.

In an embodiment the system further comprises a sensor for measuring power exerted by the drive means on the rotor, wherein the control system is adapted for controlling the direction and speed of rotation of the rotor based on pressure measured by the pressure sensor and on the measured power exerted by the drive means.

In an embodiment the grabber is adapted for measuring a width of a brick held thereby, wherein the control system is adapted for:—controlling the grabber to pick up the brick and measure a width of the brick, and place the brick on one or more layers of mortar to form part of the brick wall, wherein, based on the measured width of the brick, the brick is placed such that a front face of the brick in the wall substantially coincides with a planar front face surface of the wall. A simple manner in which the grabber can be used to measure a width of a brick, is by determining a distance between two facing portions of the grabber when a brick is clamped between those portions.

Dimensions of bricks, such as width and length, typically vary somewhat from brick to brick which can result in one brick standing out relative to another brick in the wall. By measuring the width of each brick and ensuring its front face is substantially flush with the front face surface of the wall in which it is placed, it is possible to construct a wall having a very flush front face surface, though the rear face surface may be less flush. The front face surface typically is the visible surface of the wall in a building after the building has been constructed.

In an embodiment the system further comprises a brick supply device, the brick supply device comprising: a brick measuring section, adapted for measuring the length of a brick; a conveyor adapted for supporting a plurality of bricks and for conveying a brick of the plurality of bricks to the brick measuring section; a brick cutting section, adapted for cutting a brick to a desired length; wherein the brick measuring section and the brick cutting section are in communication with the control system; wherein the control system is adapted for:
controlling the brick measuring to measure the length of a brick;
determining whether the brick should be cut to a shorter length, and if so, controlling the arm and the grabber to pick up the brick from the brick measuring section and place it in the brick cutting section, and controlling the brick cutting section to cut the brick to a desired length;
controlling the grabber to place the brick on one or more layers of mortar as part of forming the brick wall, wherein, based on the length of the brick, the brick is placed such that width of the perpend between the brick and a neighboring brick that is already placed in the wall is substantially equal to the width of a perpend between said neighboring brick and another brick that is already placed in the wall and neighbors the neighboring brick.

When the grabber picks up a brick from the measuring section, the controller has information on the length of the brick and on the position of the brick relative to the grabber. This allows the controller to control the arm and grabber to position the brick within the cutting section to allow the brick to be cut to the desired size without further measurements on the position or dimensions of the brick being required at the cutting section. It is noted that the direction of the width of a perpend usually corresponds to the length direction of the brick.

Even in case the brick is not cut to size prior to being placed in the wall, the controller may, based on the measured length of the brick, ensure that the perpends between bricks in a same horizontal stretch in a wall have a substantially equal width. Typically, the perpends will not be filled with mortar.

Preferably, during cutting of the brick in the brick cutting section, the brick is moved relative to the brick cutting section and the brick supply device. In this case, it is advantageous if the arm and grabber are controlled to place the brick in the brick cutting section in such a manner that the brick is aligned with a saw blade or jet of a water cutter or the like of the brick cutting section, that the brick can be cut by moving the brick in a substantially vertical plane towards the blade or cutter and relative to both the brick cutting section and the brick supply device.

In an embodiment the control system is adapted for controlling the arm and grabber to place the brick in the cutting section at a location in the cutting section that is based on the measured length of the brick, a desired length of the brick that is to be placed in the wall, and a location and measured length of a brick that was most recently placed in the wall. Once the arm and grabber have thus positioned the brick in the cutting section, the brick can be cut to the desired length without any further measurement or alignment of the brick being required in the cutting section.

In an embodiment the control system is adapted for, if the brick has been cut and is to be placed at an end section of a wall, controlling the grabber to place the brick in the wall such that the cut end of the brick faces a perpend between said brick and a neighboring brick. This may be done for instance by controlling the grabber to to rotate relative to the arm in this manner also rotating the brick held thereby. In this manner, it may be ensured that the less aesthetically pleasing cut ends of bricks are less visible.

According to a second aspect, the invention provides an assembly comprising: a pump for pumping mortar, the pump comprising a stator and a rotor at least partially arranged within the stator, the stator comprising an inlet opening and an outlet opening, wherein the rotor is arranged for rotating in a first direction to pump mortar from the stator through the outlet opening of the stator; an outlet section in fluid communication with the outlet opening of the stator and adjacent thereto; wherein the outlet section is spaced apart from the rotor and is detachably attached to the stator. Preferably, the assembly further comprises a pressure sensor arranged for measuring a pressure of mortar in the outlet section downstream of the rotor. It will be appreciated that the assembly may comprise any features of the pump and outlet section of the system according to the first aspect of the invention. The assembly preferably is an assembly for use with the system according to the first aspect of the invention.

The pump is preferably provided with a blocking element for blocking movement of the rotor out of a lower side of the pump during use, wherein the blocking element is arranged for contacting a lower surface of the rotor within a volume defined by the stator. In this manner, when the rotor of the pump rotates in a second direction opposite to the first direction, a downward force exerted by the mortar onto the rotor is transferred onto the blocking element of the pump, rather than onto the outlet section or onto drive means for driving the rotor. The outlet section thus does not have to be constructed to withstand contact with the rotor, but merely has to be able to withstand pressure exerted by the mortar. This allows the outlet section to be constructed as a relatively light weight component. Moreover, as the outlet does not have to be able to withstand force exerted directly thereon by the rotor, the outlet section may be manufactured using techniques other than casting and/or welding. Manufacturing the outlet section may for instance comprise 3D printing those parts of the outlet section that come into contact with mortar.

Preferably, the blocking element comprises a shaft that is held in the stator and has an upward facing surface for contacting the lower surface of the rotor.

In an embodiment a circumferential inner wall surface of the stator connects substantially smoothly to a circumferential inner wall surface of the outlet section, wherein the outlet section defines a passage for mortar along a center axis, and wherein a cross-sectional area in a plane perpendicular to said center axis and bounded by the inner wall surface of the outlet section decreases in a downstream direction along the axis. Thus, mortar can flow smoothly from the stator to the outlet section, and from the outlet section to the mortar supply line, while it is substantially prevented that mortar remains in so called “dead zones” within the outlet section. The center axis typically will be a curve with a single point of inflexion. The inner surface of the passage will typically be smoothly curved.

In an embodiment the cross-sectional area of the upstream end of the passage is no more than 3 times the cross-sectional area of the downstream end of the passage, preferably no more than 2 times. Thus, the outlet section narrows considerably from its upstream end to its downstream end, in this manner further preventing portions of mortar from becoming lodged in the outlet section, helping to ensure substantially uniform retention time of mortar in the outlet section.

In an embodiment the outlet section is spaced apart from the rotor and is detachably attached to the stator, preferably wherein the outlet section is detachably attached to the stator in such a manner that the outlet section can be detached from and attached to the stator without moving the rotor relative to the stator. This allows the outlet section to be replaced, or be temporarily removed, e.g. for cleaning and/or to allow access to an interior downstream side of the stator.

Preferably the outlet section is detachable from and attachable to the stator by sliding the outlet section relative to the stator, e.g. in a direction substantially normal to the axis of rotation of the rotor.

In an embodiment the upstream end of the outlet section has a substantially stadium-shaped cross sectional area, and the downstream end of the outlet section has a substantially disc-shaped cross sectional area.

In an embodiment the substantially disc-shaped cross sectional area of the downstream end has a radius which is substantially equal to the radius of the semi-circles of the stadium-shaped cross-sectional area at the upstream end.

In an embodiment the rotor, at the end thereof proximate to the upstream end of the outlet section, comprises a substantially disc-shaped surface, wherein when seen in projection onto a plane normal to the rotor axis and between the upstream end of the outlet section and the lower surface of the rotor, the area of the substantially disc shaped surface is between 35% and 55% of the area of the substantially stadium shaped cross sectional area, preferably between 40 and 50%. The lower surface of the rotor may thus substantially close off one side of the stadium shaped upstream end of the outlet section, while leaving open the other side of the stadium shape.

In an embodiment the rotor, at the end thereof proximate to the upstream end of the outlet section, comprises a substantially disc-shaped surface arranged for contacting the blocking element. The disc-shaped surface may thus contact the blocking element over a relatively large surface, in this manner reducing wear of both the disc-shaped surface and the contacting surface of the blocking element.

In an embodiment the rotor has a length that is between 1.2 and 1.8 times the length of the stator, preferably between 1.2 and 1.6 times the length of the stator. Thus, the rotor may extend out of the top of the stator, e.g. to be connected to a drive means for rotating the rotor within the stator.

In an embodiment the pump is a progressive cavity pump. Progressive cavity pumps have been found to be particularly suitable for pumping mortar.

In an embodiment the blocking element comprises a shaft which is provided in a corresponding receiving space within the stator, wherein the shaft bridges the downstream opening of the stator. Preferably, the shaft can be removed from the stator to allow the rotor to be moved out of the lower pard of the stator, e.g. in case access to the rotor is required.

In an embodiment the shaft comprises a flat surface for contacting the lower surface of the rotor and preventing the rotor from moving out of the lower end of the stator. Thus, in particular when the rotor is rotated in a second direction opposite to the first direction, the blocking element prevents the rotor from moving out of the stator.

In an embodiment the upstream end of the outlet section has a cross sectional area of between 75 cm³ and 500 cm³.

In an embodiment the rotor is further arranged for rotating in a second direction opposite to the first direction, wherein the blocking element is arranged for contacting the lower surface of the rotor when the rotor rotates in the second direction.

According to a third aspect the invention provides a method of constructing a brick wall using a system according to any one of claims 1-20, the method comprising using the control system to control the arm and grabber to pick up a brick from a brick supply device and place it to form part of a wall; control the arm and grabber to pick up the mortar depositing device; control the arm and grabber to move the mortar depositing device held by the grabber relative to the base while the device deposits one or more layers of mortar and while the grabber is stationary relative to the mortar depositing device.

In an embodiment the system for constructing a brick wall further comprises a drive means for driving rotation of the rotor relative to the stator; and a pressure sensor arranged for measuring a pressure of mortar downstream of the rotor, preferably wherein the pressure sensor is arranged for measuring the pressure in the outlet section, in the mortar supply line, and/or in the mortar depositing device; wherein the method further comprises using the control system to control the drive means such that the pressure measured by the pressure sensor while the mortar depositing device deposits the one or more layers of mortar remains substantially in the range of 0 to 5 atm above atmospheric pressure, preferably 1 to 5 atm above atmospheric pressure,

In an embodiment, the method further comprises using the control system to, upon the pressure sensor measuring a sudden drop in pressure, control the drive means to rotate in a second direction opposite to the first direction.

In an embodiment the method further comprises using the control system to control the arm and the grabber holding the mortar depositing device to move to a recycle position in which the one or more openings are arranged for depositing mortar into the hopper.

Preferably, the arm and the grabber holding the mortar depositing device are further controlled by the control system to move to the recycle position in case of a sudden drop in pressure measured by the pressure sensor.

In an embodiment the mortar has a value of the slump test as measured according to ISO standard EN 12350-2:2019 of between 22 and 40 cm, in particular between 24 and 38 cm.

According to a fourth aspect, the invention provides a computer-readable medium, medium comprising instructions which, when executed by a control system of a system for constructing a brick wall according to the invention, cause the control system to carry out the method according to the third aspect of the invention.

### BRIEF DESCRIPTION OF THE DRAWINGS

Embodiments of the invention will now be illustrated in the drawings, in which like reference numerals refer to like structures, and in which:

FIGS. 1A and 1B show a system for constructing a brick wall in accordance with a first embodiment of the invention, respectively with a mortar depositing device placed in a recycle position, and with the mortar depositing device held in a grabber of the system;

FIG. 2A shows respectively an isometric detail of the pump and the outlet section;

FIGS. 2B and 2C each show portions of an exploded view of the pump and outlet section of FIG. 2A;

FIG. 2D shows and cross-sectional view of the outlet section at the plane where it connects to the stator of the pump, and a front view of the outlet section at the plane where it connects to the mortar supply line; and

FIG. 3 shows a system according to a second embodiment of the invention, in which the system further comprises a brick supply device.

### DETAILED DESCRIPTION

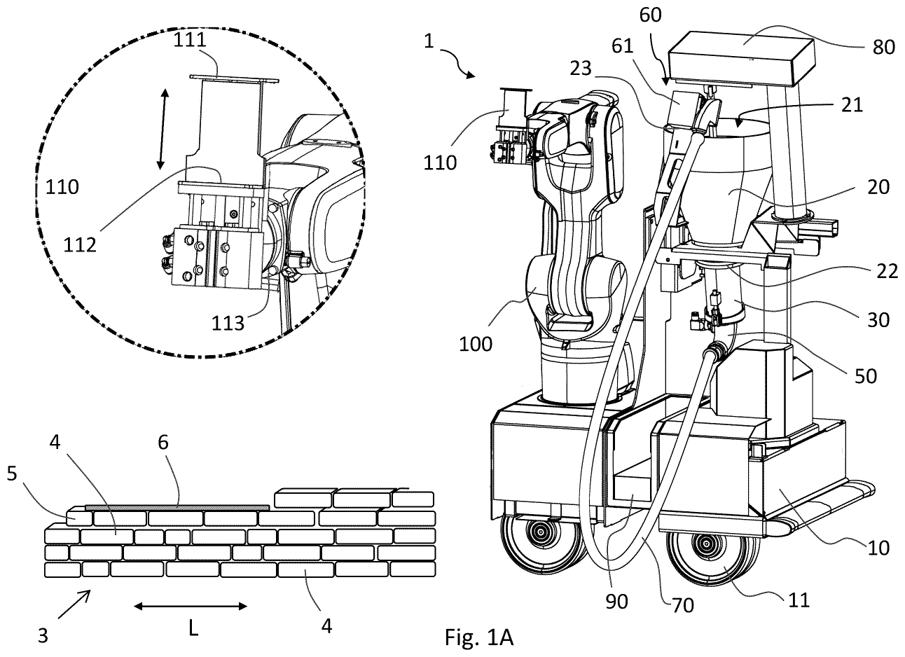

FIG. 1A shows a system 1 for constructing a brick wall 3 according to an embodiment of the invention. The system 1 comprises a moveable base 10, on which a hopper 20 for holding mortar therein is placed, as well as an arm 100 which is moveable relative to the base and which comprises a grabber 100 for picking up bricks. In the example show, the arm is a part of a robot having 6 degrees of freedom. The mortar used typically is a low-viscosity mortar which can easily be pumped within the system 1 at relatively low pressures of between 1 and 5 atm.

The base 10 is provided with wheels 11 which allowing the base 10 to be moved along the ground surface to different positions where the wall 3 is to be constructed.

The hopper has an open inlet opening 21 at its upper end, and an outlet opening 22 at its lower end. The outlet opening 22 at the lower end connects to a pump, which in the example shown is a progressive cavity pump 30. Drive means 80 in the form of a motor are provided for driving rotation of a rotor of the pump 30 at a desired speed and in a desired direction to pump the mortar.

An outlet section 50 tapers from a downstream end of the pump 30, to which the outlet section is smoothly connected, to an upstream end of a flexible mortar supply line 70 which in the example shown has a length of about 3 m. At its downstream end the mortar supply line 70 is connected to mortar depositing device 60 which is adapted for depositing layers of mortar 6 onto substantially horizontal top surfaces of bricks 4,5 in a horizontal row of bricks that already form part of a wall. The mortar depositing device 60 further comprises a block 61 that is adapted to detachably attach to a mortar depositing device support 23 that is arranged near the upper inlet 22 of the hopper. In the example shown, the block 61 comprises a permanent magnet for detachably attaching to the support 23 which is made from steel, though another means of detachably attaching the block to the support, e.g. comprising an electromagnetic magnet, a vacuum suction cup, a hook, a pin and hole, slotted connection, etc. may be used instead. The block 61 has a width and height which allows it to be picked up using the arm 100 and grabber 110. In the example shown this width and height correspond substantially to a width and height of bricks 4,5 in the wall. In FIG. 1A, the bricks lie with their length directions along direction L of the wall 3, with the front sides of the bricks and the front side of the wall 3 facing the viewer. The width of a brick 4,5 is the distance between a front side of the brick in the wall, and an opposite back side of said brick in the wall, and the height of a brick is the vertical height of a brick 4,5 in the wall.

FIG. 1A shows the mortar depositing device 60 in a recycle position, in which mortar that is pumped from the hopper 20 via pump 30, outlet section 50, and mortar supply line 70 out of the mortar dispensing device 60 is recycled through the inlet opening 21 back into the hopper 20. In this manner, mortar can be cycled through the supply line to displace any air pockets that may be present in the supply line 70, pump 30 and/or outlet section 50. When, after recycling the mortar, the mortar depositing device 60 is subsequently used to deposit mortar on bricks of the partially constructed wall 3, the resulting flow of mortar is substantially continuous, i.e. without gaps due to air pockets. A further advantage is that once air pockets have been substantially removed from the supply line 70, it is possible to pump the mortar in a reverse direction, i.e. control the pump 30 to move mortar from the supply line 70 back towards the hopper 20. Thus,, once a line of mortar has been completely deposited on the partially constructed wall, just prior to moving the dispensing device away from the wall, the pump is operated in the reverse direction, so that the dispensing device can be moved away from the wall substantially without mortar dripping from the mortar dispensing device.

The system 1 further comprises a control system 90 that is adapted for controlling the arm 100 and grabber 110 to pick up a brick from a brick supply device (not shown), and subsequently place it on one or more layers of mortar 6 that have been deposited on bricks 4,5 of the brick wall.

The left-hand side of FIG. 1A shows the grabber 110 in more detail. The grabber 110 comprises an first end portion 111 which is stationary relative to a connector 113 by means of which the grabber 110 is attached to the arm 100, and an actuated second end portion 112 which is moveable towards and away from the first end portion along the direction indicated by the arrow, to clamp a brick between the end portions 111,112 or release it therefrom. Besides picking up a brick, the grabber may further be used to provide the control system 90 with an indication of a width of the brick it holds, by indicating a distance between the first and second end portions 111,112 when the clamping the brick. The unit control is adapted for using the information on the width of the brick to control the arm and grabber to position the brick such that the front-facing surfaces of the bricks in the wall lie substantially in a same plane. Due to slightly differences in widths between bricks, the rear side surfaces of the bricks may lie in planes that are offset relative to each other to a greater extent.

FIG. 1B shows the same system 1, though for reasons of clarity, the wall 3 and mortar supply line 70 have been omitted from FIG. 1B. It will be appreciated that the mortar supply line remains present in the system 1. In FIG. 1B, the grabber 110 has been used to pick up the mortar supply device 60 by clamping the block 61 of the mortar supply device 60 between the first and second end portions 111,112. Thus, the same grabber 110 and arm 100 are used for picking up a brick and placing it in the partially constructed wall, and for picking up the mortar depositing device 60 and move it along a top surface of the partially constructed wall while mortar is deposited on top surfaces of bricks.

The mortar depositing device 60 comprises a nozzle 62 with two outlet openings 62a,62b for simultaneously depositing two layers of mortar onto a substantially horizontal top surface of brick in a row of bricks that already forms part of a wall. It has been found that by placing two spaced apart layers of mortar on top of the bricks instead of a single layer, dripping of the mortar is substantially reduced.

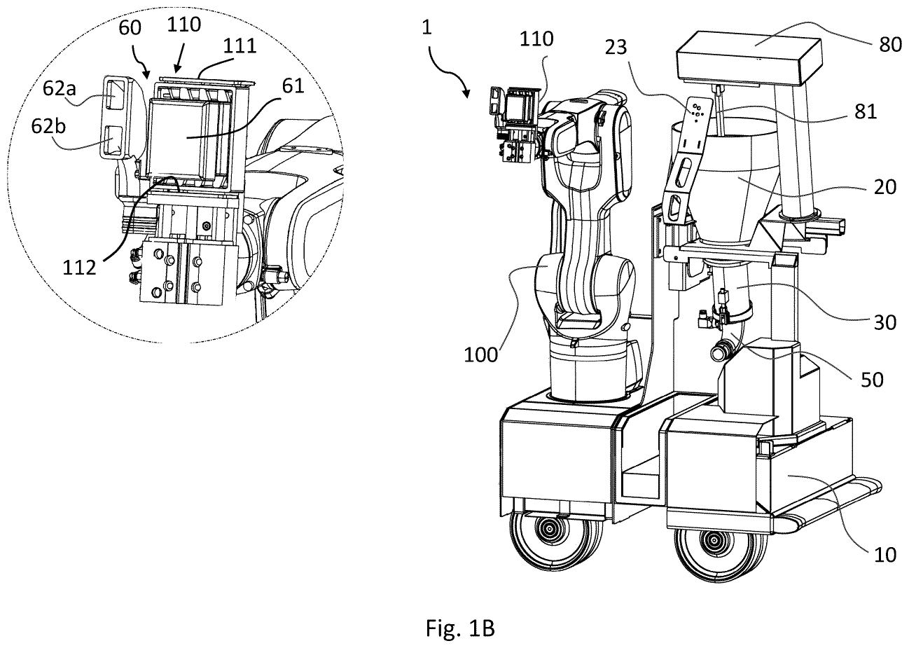

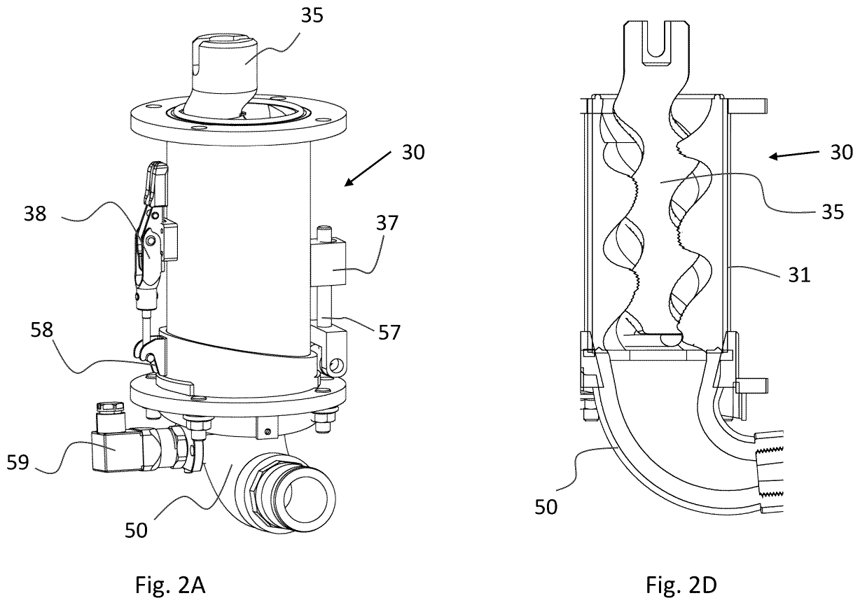

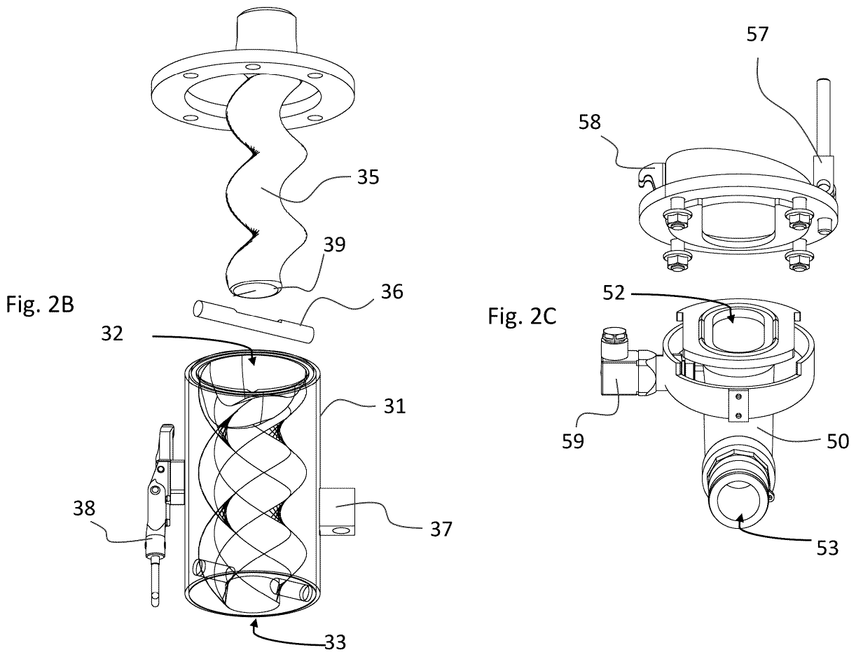

FIG. 2A shows an isometric view of the pump 30 and outlet section 50. FIGS. 2B and 2C respectively show exploded views of the pump 30 and the outlet section 50, wherein in FIG. 2B the stator 31 of the pump 30 has been shown partially transparent. The pump 30 is a progressive cavity pump and comprises the stator 31 and a rotor 35. Though not shown in FIG. 2A, the rotor is at its upper side connected to shaft 81 of the motor 80, so that the rotor can rotate around an axis in a first rotational direction, or in a rotational direction opposite thereto. The outlet section 50 is detachably attached to the stator 31 by means of a latch mechanism 38,58, of which a lever part 38 is attached to the stator 31, and of which a hook part 58 is attached to the outlet section. In FIG. 2A, the lever part 38 catches the hook part 58, in this manner holding the outlet section 50 in place relative to the stator 31. On a side of the stator and outlet section opposite from the latch mechanism 38,58, a sliding mechanism 37,57 is provided which allows sliding movement of the outlet section relative to the stator when the lever is in a released position.

Thus, when the lever part 58 is moved to a released position but still engages the hook part 58, the outlet section 50 can slide vertically downward relative to the stator 31, in this manner providing access to the lower side interior of the stator while the outlet section remains supported by the stator. Alternatively, when in the released position, the lever part 38 may be disengaged from the hook part 58, in which case the entire outlet section can be removed from the stator.

A pressure sensor 59 is provided for measuring a pressure of the mortar in the outlet section 50 downstream of the rotor 35. Measurements from the pressure sensor are used by the control system 90 to control the motor 80 in such a manner that, during depositing of one or more layers of mortar by the depositing device, the pressure remains substantially in the range of 1 to 5 atm. This pressure range allows more accurate deposition of mortar and is considerably lower than the pressure that is used for pumping conventional mortars that are used in constructing brick walls.

As can be seen more clearly in the exploded view of FIG. 2B, the length of the rotor 35 is about 1.3 times the length of the stator 31 as measured along the axis of rotation of the rotor. At the lower end of the stator 31, a shaft 36 is provided in a corresponding receiving space 34 within the stator 31, the shaft bridging the downstream opening of the stator. The shaft 36 has a flat surface for contacting the lower surface 39 of the rotor and preventing the rotor from moving out of the lower end of the stator. It is thus ensured that the rotor remains spaced apart from outlet section 50, allowing the outlet section to be detached without the rotor falling out of the stator. As the outlet section 50 does not support the rotor, the strength requirements on the outlet section are reduced, allowing it to be manufactured in a cost effective manner, e.g. using 3D printing techniques. Movement of the rotor 35 out of the upper end of the stator 31 is prevented by the downward force exerted on the rotor by the shaft 81 of the drive means 80.

The stator 31 has an inlet opening 32 which is in fluid connection with the outlet opening 22 of the hopper 20. The outlet opening 33 of the stator 31 is substantially stadium shaped, and the inner wall of the stator smoothy transitions into the inner wall of the outlet section 50 when the outlet section is the attached to the stator in the manner shown in FIG. 2A. The area of the stadium shaped opening at the upstream end 52 of the outlet section 50 is less than 3 times greater than the area of the circular opening at the downstream end 53 of the outlet section 50, to prevent excessive pressure being exerted on mortar when it is pumped through the outlet section.

FIG. 2D shows a longitudinal cross-sectional of the pump and outlet section, which more clearly shows the inner wall of the stator smooth transitioning into the inner wall of the outlet section. The outlet section defines a passage for mortar along a center axis, such that a cross-sectional area in a plane perpendicular to said center axis and bounded by the inner wall surface of the outlet section decreases monotonically in a downstream direction for the mortar along the center axis.

With regard to the assembly of the pump and outlet section shown in FIGS. 2A-2D, it noted that this assembly may also be used separately from the rest of the system according to the first embodiment of the invention.

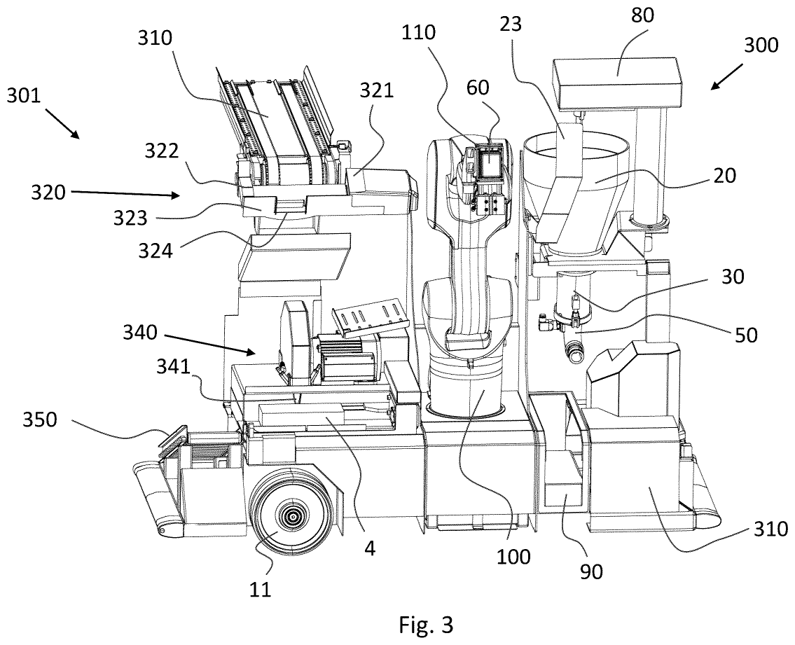

FIG. 3A shows a system 300 according to a second embodiment of the invention, in which the right hand side of the system is substantially the same as in the system of FIG. 1, with like reference numerals referring to like structures. Again, the mortar supply line has been omitted for reasons of clarity, but should be understood to be part of the system. The system further comprises a brick supply device 301 that is provided on the moveable platform 310 on which the moveable arm 100, hopper 20, pump 30, outlet section 50 and controller 90 are provided. FIG. 3B shows the brick supply device 301 in more detail.

The brick supply device 301 comprises a conveyor 310 on which a plurality of bricks can be placed. The conveyor is adapted for transporting a single brick from said plurality to a brick measuring section 320 which is adapted for measuring a length of the brick. The conveyor moves a brick to the measuring section 320, such that one longitudinal sidewall of the brick rests against sidewall 324 of the measuring section 320. The sidewall 324 is provided with a cutout portion 323, for allowing the first end portion 111 and/or second end portion 112 of the grabber to at least partially pass therethrough in order to clamp against a sidewall of the brick.

The brick measuring section comprises a moveable first end wall 321, which can be actuated to move along the longitudinal direction of the brick to push the brick against a facing second end wall 322. By determining the position of the first end wall 321 relative to the second end wall 322 when a brick contacts both, the length of the brick can be determined. Additionally, when the brick contacts both the first end wall 321, the second end wall 322 an the sidewall 324, the brick is aligned relative to the brick supply device. In this manner, when the grabber 110 picks up the from the measuring section, the locations of the front face surface, the rear face surface and the side surfaces of the brick relative to the grabber are defined, and can be used by the controller to accurately position the brick in a wall.

In most cases, the brick will be picked up by the grabber without having to cut the length of the brick to size, and the grabber will move the brick from the measuring section onto a layer of mortar on the wall. However, if the length of the brick is to be adjusted by cutting it, the controller 90 instead controls the grabber 110 to move the brick it has picked up to cutting section 340. As the length of the brick as well as the locations of the side surfaces of the brick relative to the grabber are known, and as the position of saw blade 341 relative to the grabber 110 is known, the grabber can accurately position the brick 4 relative to the saw blade, so that the blade may be used to cut the brick to the desired length. Next, the grabber picks up the portion of the brick that is to be placed in the wall, and places it in the wall. The remaining cut-off portion of the brick is pushed moved out of the cutting section onto conveyor 350.

Advantageously, while a brick is being cut to a desired length, the grabber may be used consecutively to pick up one or more other brick from the conveyor 310 and place it/these in the wall by the grabber while the cutting section cuts the brick that was picked up earlier.

In case a brick that is cut to a desired length is to be placed at a corner section of the wall, or at a section adjacent an opening in the wall, e.g. an opening for a door or window sill, then the controller may control the arm and grabber to position the brick in the wall in such a manner that the cut side of the brick is substantially hidden from view to provide a more aesthetically pleasing appearance.

In summary, the invention provides a system for constructing a brick wall, comprising: a base, a hopper for mortar, a pump comprising a stator and a rotor and in fluid connection with the hopper, an outlet section in fluid communication with an outlet opening of the stator and adjacent thereto; a mortar depositing device having an opening for depositing mortar; a mortar supply line interconnecting the mortar depositing device with the outlet section; and a robot comprising a grabber adapted for picking up a brick from a brick supply device; and a control system adapted for controlling the robot to, using the grabber, pick up a brick from the brick supply device and place it to form part of the wall; wherein the mortar depositing device is adapted for being picked up by the grabber, and for being held by the grabber while the grabber moves relative to the base, wherein the control system further is adapted for controlling the robot to move the grabber and the mortar depositing device held thereby relative to the base while the device deposits one or more layers of mortar and while the grabber is stationary relative to the mortar depositing device. The system is particularly suited for use with a low-viscosity mortar.

1. A system for constructing a brick and mortar wall, comprising:
a base;
a hopper mounted to the base and adapted for holding mortar therein, the hopper comprising an inlet opening and an outlet opening;
a pump for pumping mortar, the pump comprising a stator and a rotor at least partially arranged within the stator, the stator comprising an inlet opening in fluid communication with the outlet opening of the hopper, the stator further comprising an outlet opening, wherein the rotor is arranged for rotating in a first direction to pump mortar from the stator through the outlet opening of the stator;
an outlet section in fluid communication with the outlet opening of the stator and adjacent thereto;
a mortar depositing device having one or more openings for depositing mortar;
a mortar supply line interconnecting the mortar depositing device with the outlet section;
an arm moveable relative to the base, the arm comprising a grabber, wherein the grabber is moveable relative to the base and is adapted for picking up a brick from a brick supply device; and
a control system adapted for controlling the arm and the grabber to pick up a brick from the brick supply device and place it to form part of the wall;
wherein
the mortar depositing device is adapted for being picked up by the grabber, and for being held by the grabber while the grabber moves relative to the base,
wherein the control system further is adapted for:
controlling the arm and the grabber to move the mortar depositing device held by the grabber relative to the base while the device deposits one or more layers of mortar and while the grabber is stationary relative to the mortar depositing device.

2. The system according to claim 1, further comprising:
a drive means for driving rotation of the rotor relative to the stator; and
a pressure sensor arranged for measuring a pressure of mortar downstream of the rotor, in the outlet section, in the mortar supply line, and/or in the mortar depositing device; and
wherein the control system further is adapted for:
controlling the drive means such that the pressure measured by the pressure sensor while the mortar depositing device deposits the one or more layers of mortar remains substantially in the range of 0 to 5 atm above atmospheric pressure.

3. The system according to claim 2, wherein the control system further is adapted for, upon the pressure sensor measuring a sudden drop in pressure, controlling the drive means to rotate in a second direction opposite to the first direction.

4. The system according to claim 1, wherein the control system is adapted for controlling the arm and the grabber holding the mortar depositing device to move to a recycle position in which the one or more openings are arranged for depositing mortar into the hopper.

5. (canceled)

6. The system according to claim 1, wherein the control system is adapted for controlling the arm and the grabber holding the mortar depositing device to move to a standby position and then releasing the depositing device at said position.

7. (canceled)

8. The system according to claim 1, wherein the control system is further adapted to control the drive means to rotate the rotor in a second direction opposite to the first direction at the end of depositing one or more layers of mortar.

9. The system according to claim 1, wherein a circumferential inner wall surface of the stator connects substantially smoothly to a circumferential inner wall surface of the outlet section, wherein the outlet section defines a passage for mortar along a center axis, and wherein a cross-sectional area in a plane perpendicular to said center axis and bounded by the inner wall surface of the outlet section decreases monotonically in a downstream direction along the axis.

10. (canceled)

11. The system according to claim 1, wherein the outlet section is spaced apart from the rotor and is detachably attached to the stator.

12. The system according to claim 8, wherein the outlet section is detachable from and attachable to the stator by sliding the outlet section relative to the stator;

13. The system according to claim 1, wherein the pump is provided with a blocking element for blocking movement of the rotor out of a lower side of the pump during use, wherein the blocking element is arranged for contacting a lower surface of the rotor within a volume defined by the stator.

14. (canceled)

15. The system according to claim 2, further comprising a sensor for measuring power exerted by the drive means on the rotor, wherein the control system is adapted for controlling the direction and speed of rotation of the rotor based on the pressure measured by the pressure sensor and on the measured power exerted by the drive means.

16. The system according to claim 1, wherein the grabber is adapted for measuring a width of a brick held thereby, wherein the control system is adapted for
controlling the grabber to pick up the brick and measure a width of the brick, and place the brick on one or more layers of mortar to form part the brick wall, wherein, based on the measured width of the brick, the brick is placed such that a front face surface of the brick in the wall substantially coincides with a planar front face surface of the wall.

17. The system according to claim 1, wherein the brick supply device comprising:
a brick measuring section, adapted for measuring the length of a brick;
a conveyor adapted for supporting a plurality of bricks and for conveying a brick of the plurality of bricks to the brick measuring section;
a brick cutting section, adapted for cutting a brick to a desired length;
wherein the brick measuring section and the brick cutting section are in communication with the control system;
wherein the control system is adapted for
controlling the brick measuring section to measure the length of a brick;
determining whether the brick should be cut to a shorter length, and if so, controlling the arm and the grabber to pick up the brick from the brick measuring section and place it in the brick cutting section, and controlling the brick cutting section to cut the brick to a desired length; and
controlling the grabber to place the brick on one or more layers of mortar to form part of the brick wall, wherein, based on the length of the brick, the brick is placed such that a width of the perpend between the brick and a neighboring brick that is already placed in the wall is substantially equal to a width of a perpend between said neighboring brick and another brick that is already placed in the wall and neighbors the neighboring brick.

18-20. (canceled)

21. An assembly, comprising:
a pump for pumping mortar, the pump comprising a stator and a rotor at least partially arranged within the stator, the stator comprising an inlet opening and an outlet opening, wherein the rotor is arranged for rotating in a first direction to pump mortar from the stator through the outlet opening of the stator, wherein the pump is provided with a blocking element for blocking movement of the rotor out of a lower side of the pump during use, wherein the blocking element is arranged for contacting a lower surface of the rotor within a volume defined by the stator; and
an outlet section in fluid communication with the outlet opening of the stator and adjacent thereto; wherein the outlet section is spaced apart from the rotor and is detachably attached to the stator.

22. The assembly according to claim 14, wherein a circumferential inner wall surface of the stator connects substantially smoothly to a circumferential inner wall surface of the outlet section, wherein the outlet section defines a passage for mortar along a center axis, and wherein a cross-sectional area in a plane perpendicular to said center axis and bounded by the inner wall surface of the outlet section decreases monotonically in a downstream direction along the center axis.

23. (canceled)

24. The assembly according to claim 14, wherein the outlet section is detachable from and attachable to the stator by sliding the outlet section relative to the stator.

25. The assembly according to claim 14, wherein the rotor, at the end thereof proximate to the upstream end of the outlet section, comprises a substantially disc-shaped surface, wherein when seen in projection onto a plane normal to the rotor axis and between the upstream end of the outlet section and the lower surface of the rotor, the area of the substantially disc-shaped surface is between 35% and 55% of the area of the substantially stadium-shaped cross sectional area.

26. The assembly according to claim 14, wherein the upstream end has a substantially stadium shaped cross sectional area, and wherein the downstream end has a substantially disc-shaped cross sectional area.

27. A method for constructing a brick wall using a control system, the method comprising:
controlling an arm and grabber to pick up a brick from a brick supply device and place it to form part of a wall, wherein the art is movable relative to a base on the device, and wherein the and includes the grabber and the grabber is movable relative to the base and is adapted to pick up a brick from a brick supply device;
controlling the arm and grabber to pick up the mortar depositing device; and
controlling the arm and grabber to move the mortar depositing device held by the grabber relative to the base while the mortar depositing device deposits one or more layers of mortar and while the grabber is stationary relative to the mortar depositing device.

28-30. (canceled)

31. A non-transitory computer-readable medium comprising instructions which, when executed by a control system of a device for constructing a brick wall, cause the control system to:
control an arm and a grabber to pick up a brick from a brick supply device and place it to form part of a wall, wherein the arm is movable relative to a base on the device, and wherein the arm includes the grabber and the grabber is movable relative to the base and is adapted to pick up a brick from a brick supply device;
control the arm and the grabber to pick up a mortar depositing device; and
control the arm and the grabber to move the mortar depositing device held by the grabber relative to the base while the mortar depositing device deposits one or more layers of mortar and while the grabber is stationary relative to the mortar depositing device.
